(19) United States
(12) Patent Application Publication
(10) Pub. No.: US 2005/0138770 A1
(43) Pub. Date: Jun. 30, 2005

(54) Composite pressure-cast bar

(76) Inventor: C. T. Chiou, Taipei Hsien (TW)

Correspondence Address: C.T. CHIOU, 235 CHUNG-HO BOX 8-24, TAIPEI HSIEN, 235, TW

(21) Appl. No.: 10/747,502

(22) Filed: Dec. 30, 2003

(51) Int. Cl. E05D 15/00

(52) U.S. Cl. 16/87 R

(57) ABSTRACT

A composite pressure-cast bar comprises a core of a foam material that is a mixture of a recycled material, such as wood power, and a polyvinyl chloride or polystyrol plastic material. The composite pressure-cast bar further includes an inner layer made of glass fibers and an outer layer of substantially solid material. The outer is a mixture of a recycled material, such as wood power, and a polyvinyl chloride or polystyrol plastic material. A wood-grained pattern can be thermal-printed on the outer surface of the outer layer for ornamental purposes. The composite pressure-cast bar thus formed has advantages of: being fireproof and waterproof, being firm enough to secure nails inserted therein, being environment-friendly and being of low production cost. The composite pressure-cast bar can be made in a variety of lengths, which significantly reduce material loss due to cutting.

### FIELD OF INVENTION

The present invention relates to composite pressure-cast bars, more particularly to a composite pressure-cast bar which is utilized as a curtain rod or a fixing frame member for interior decoration. The composite pressure-cast bar is fireproof and waterproof. It can also be made in a variety of lengths, significantly reducing material loss due to cutting.

### DESCRIPTION OF THE PRIOR ART

Curtains behind windows not only decorate windows but also shield the people inside houses from lights and noises. They also provide mechanisms for guarding privacy and for sustaining indoor temperature. To achieve the above functions, curtain pieces are usually slidably hanged on a curtain rod against a window. A curtain rod is usually made of relatively strong material such as solid wood or aluminum for supporting the weight of curtain pieces. Compared with solid wood, aluminum is more expensive and not as tough. It also cannot display a wood-like pattern.

Therefore, solid wood, because of its toughness and outlook, is preferably chosen for making curtain rods. However, solid wood is not an environment-friendly material since it is produced via deforesting. It is therefore necessary to invent a composite material for building bars for interior decoration, such as curtain rods and fixing frame members, that are strong enough to support curtain pieces and to secure nails embedded therein. Though made of recycled materials, it should be able to simulate the surface patterns of solid wood for ornamental purposes.

### SUMMARY OF THE INVENTION

Accordingly, the primary object of the present invention is to provide a composite press-formed bar comprising a core, an inner layer and an out layer. The inner and outer layers are mixtures of a recycled material, such as wood power, and a polyvinyl chloride or polystyrol plastic material. The inner is made of glass fibers. The composite press-formed bar thus formed is environment-friendly.

The secondary object of the present invention is to provided a composite press-formed bar on which a wood-grained pattern can be thermal-printed for ornamental purposes.

The third object of the present invention is to provide a composite pressure-cast bar that is fireproof as well as waterproof.

The fourth object of the present invention is to provide a composite press-formed bar that is tough enough to secure nails inserted therein.

The fifth object of the present invention is to provide a composite press-formed bar that can be made in a variety of lengths, which significantly reduce material loss due to cutting.

### DESCRIPTION OF THE DRAWINGS

FIG. 1 is a cross-sectional view of the first embodiment of the present invention wherein the cross-section is circular.

FIG. 2 is a cross-sectional view of the second embodiment of the present invention wherein the cross-section is substantially square.

### DETAILED DESCRIPTION OF THE PREFERRED EMBODIMENTS

The various objects and advantages of the present invention will be more readily understood from the following detailed description of preferred embodiments, when read in conjunction with the appended drawings.

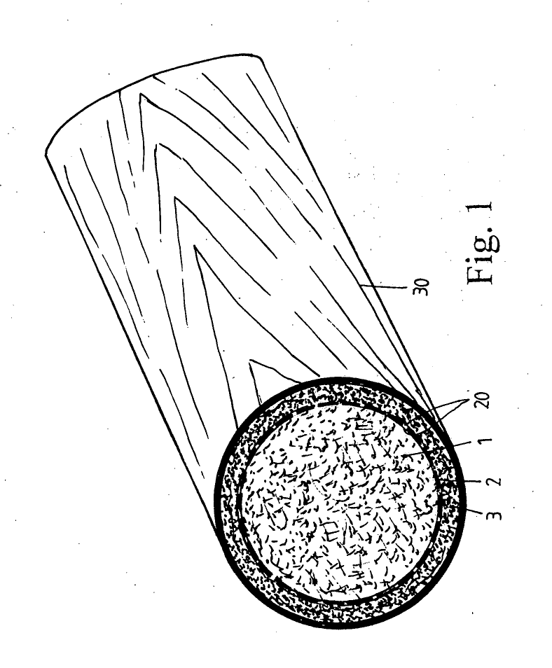

Referring to FIG. 1, the first preferred embodiment of the present invention as a composite pressure-cast bar of circular cross-section comprises a core 1, an inner layer 2 and an outer layer 3. The core 1 consists of a foam material, which is a mixture of a recycled material such as wood powder and a polyvinyl chloride or polystyrol plastic material. The inner layer 2 is made of glass fibers. The outer layer 3 consists of a substantially solid material, which is a mixture of a recycled material such as wood powder and a polyvinyl chloride or polystyrol plastic material. A wood-grained pattern 30 is thermal-printed on the outer surface of the outer layer 3 for ornamental purposes. The core 1 and the outer layer 3 sandwich the inner layer 2 by being respectively connected with the inner surface and the outer surface of the inner layer 2 by thin glue layers 20. The composite pressure-cast bar thus formed has advantages of: (1) being fireproof and waterproof, (2) being firm enough to secure nails inserted therein, (3) being environment-friendly and (4) being of low production cost. The composite pressure-cast bar can be made in a variety of lengths, which significantly reduce material loss due to cutting.

When used in interior decoration, the first preferred embodiment of the present invention is preferably used as a curtain rod to which curtain pieces can be slidably connected by curtain rings.

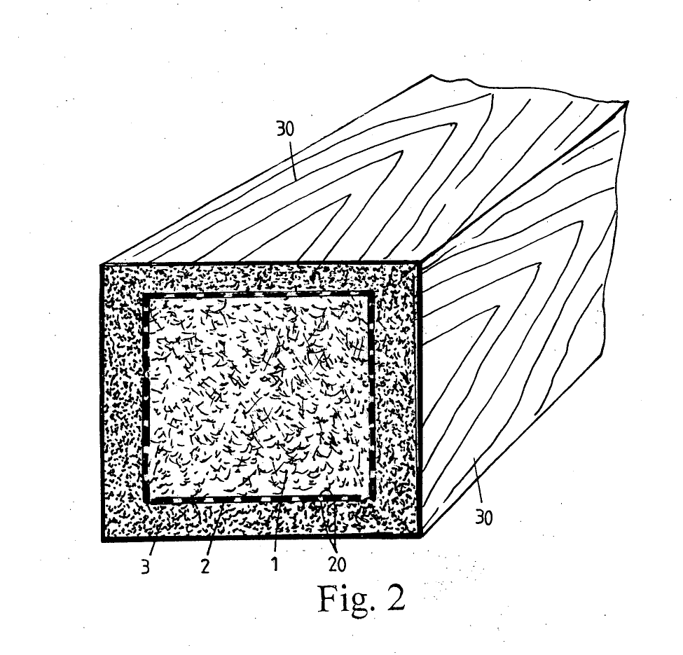

Referring to FIG. 2, the second preferred embodiment of the present invention as a composite pressure-cast bar of substantially square cross-section comprises a core 1, an inner layer 2 and an outer layer 3. The core 1 consists of a foam material, which is a mixture of a recycled material such as wood powder and a polyvinyl chloride or polystyrol plastic material. The inner layer 2 is made of glass fibers. The outer layer 3 consists of a substantially solid material, which is a mixture of a recycled material such as wood powder and a polyvinyl chloride or polystyrol plastic material. A wood-grained pattern 30 is thermal-printed on the outer surface of the outer layer 3 for ornamental purposes. The core 1 and the outer layer 3 sandwich the inner layer 2 by being respectively connected with the inner surface and the outer surface of the inner layer 2 by thin glue layers 20. Being firm enough to secure nails inserted therein, the second preferred embodiment of the present invention is preferably used as a fixing frame member that are attached to a wall of a building.

The present invention is thus described, and it will be obvious that the same may be varied in many ways. Such variations are not to be regarded as a departure from the spirit and scope of the present invention, and all such modifications as would be obvious to one skilled in the art are intended to be included within the scope of the following claims.

1. A composite pressure-cast bar, comprising:
a core of a foam material, said core being a mixture of a recycled material and a plastic material selected from the group containing polyvinyl chloride and polystyrol;
an inner layer made of glass fibers, said inner layer surrounding said core; and
an outer layer of substantially solid material, said outer layer being a mixture of a recycled material and a plastic material selected from the group of polyvinyl chloride and polystyrol, said outer layer surrounding said core and said inner layer; and an outer surface thereof being formed with decorating textures;
whereby said composite pressure-cast bar is fireproof and waterproof, firm enough to secure nails embedded therein.

2. The composite pressure-cast bar of claim 1, wherein said recycled material is wood powers.

3. The composite pressure-cast bar of claim 1, wherein the texture is wood-grained patterns which are thermal-printed on the outer surface of said outer layer for ornamental purposes.

4. The composite pressure-cast bar of claim 2, wherein the bar is a curtain rod.

5. The composite pressure-cast bar of claim 1, wherein the bar has a circular cross-section.

6. The composite pressure-cast bar of claim 1, wherein the bar has a square cross-section.
